(19) United States
(12) Patent Application Publication
(10) Pub. No.: US 2024/0231779 A1
(43) Pub. Date: Jul. 11, 2024

(54) AUTOMATIC OPTIMIZATION METHOD FOR GRAPHICAL PROGRAMMING CONTROL LAYOUT

(71) Applicant: South China University of Technology, Guangzhou (CN)

(72) Inventors: Han HUANG, Guangzhou (CN); Ziheng WU, Guangzhou (CN); Hongyue WU, Guangzhou (CN); Yihui LIANG, Guangzhou (CN); Zhifeng HAO, Guangzhou (CN)

(73) Assignee: South China University of Technology, Guangzhou (CN)

(21) Appl. No.: 16/605,502

(22) PCT Filed: Nov. 15, 2017
(86) PCT No.: PCT/CN2017/111116

§ 371 Date: Jan. 22, 2022

(30) Foreign Application Priority Data
Apr. 18, 2017 (CN) 201710254819.4

(51) Int. Cl. G06F 8/41; G06F 8/34

(52) U.S. Cl. CPC G06F 8/443; G06F 8/34

(57) ABSTRACT

The present invention provides an automatic optimization method for graphical programming control layout, comprises: freely combining, by a user, graphical modules as needed to perform programming, after programming controls are moved each time, firstly determining whether the programming controls in a program are intersected or not, then positioning to each overlapped programming control, and calculating a moving distance and a moving direction of the programming controls under a non-overlapping condition. The present invention is an automatic optimization method designed based on graphical programming software layout, and performing layout rearrangement of programming controls does not require manual operation. All the programming controls can be automatically arranged by utilizing the method, and moreover, the overlapped programming controls can be ensured to be moved to a proper location by a minimum distance.

### TECHNICAL FIELD

The present invention mainly relates to the field of graphical programming technologies, and more particularly, to an automatic optimization method for graphical programming control layout.

### BACKGROUND

With the continuous development of Internet technology and society, the Internet is gradually playing an increasingly important role in our life. At the same time, with the popularity of the Internet, programming education has gradually been concerned by people. As early as in 2012, President of the United States Barack Obama proposed that all people should learn programming, promoted the public welfare activity of “programming for an hour” throughout the country, and called on primary and secondary school students in the United States to learn programming. The education of children's programming is becoming more and more important. In an interview given by Apple's father Jobs before his death, he once said that everyone in this country should learn programming because it teaches you how to think. As said, many celebrities including Bill Gates, Mark Zuckerberg and Jack Dorsey came to call for children to participate in computer programming at the same time. Because this concept is deeply rooted in the hearts of the people, technology giants are also involved in programming education for children. Therefore, graphical programming language came into being. Graphical programming is easy to operate and understand, and users only need to drag, combine and connect the programming modules to obtain a certain model, so as to achieve a certain effect. Graphical programming software can enable children to develop their imagination and creativity to a great extent and cultivate their basic programming logic and thinking. At present, the graphical programming software in the market is basically that each graphical object is a code block or a corresponding controller, the users can splice them together to create simple functions, then combine the simple functions one by one, and then convert them into some high-level language to be transmitted to the controller, and the target code is analyzed by the compiler in the controller. During graphical programming, when the number of programming controls is increased to a certain scale, the layout will be extremely disordered, and the controls are overlapped with each other, so that it is difficult for the users to use the controls for programming. For the problem above, the present invention is intended to automatically optimize graphical programming control layout to avoid the situations of disordered layout, overlapping of controls with each other and the like. The automatic optimization method for layout can also make the programming interface more friendly and easy to operate, which greatly improves a programming efficiency.

### SUMMARY

According to the present invention, under a complex programming program in the current graphical programming field, a programming interface is prone to the situations of disordered layout, overlapping of controls with each other and the like with the increase of the number of programming controls. The present invention is intended to automatically optimize graphical programming control layout to avoid the situations of disordered layout, overlapping of controls with each other and the like.

The object of the present invention is achieved through one of the following technical solutions.

An automatic optimization method for graphical programming control layout comprises the following steps of:
(a) defining a programming module chain;
(b) determining a reference module chain based on the module chain defined in the step (a);
(c) judging an overlapped status of the module chain;
(d) calculating a moving distance of the module chain; and
(e) calculating a moving direction of the module chain and outputting an optimized layout structure.

Further, the method for defining the module chain in the step (a) is to define controls with a parent-child relationship and without a connecting relationship as module chains based on a data structure among controls and a connection status among controls, and after all the programming controls are traversed, n module chains can be obtained:

$$module ( {polygon}_{1} , {polygon}_{2} , … , {polygon}_{n} ) , {polygon}_{i} = \{ ( {x}_{i , j} , {y}_{i , j} ) \vert j = 1 , 2 , … , {m}_{i} \} ,$$

i=1, 2, . . . , n, wherein i represents a module chain number, j represents a module number in a module chain, and x_{i,j}, y_{i,j} represent an abscissa and an ordinate of a j^{th} module in an i^{th} module chain;
a new module chain formed after a dragging operation of graphical programming is as follows: Polygon={(xⱼ, yⱼ)|j=1, 2, . . . , T}, wherein j represents a module number in a module chain, xⱼ, yⱼ represent an abscissa and an ordinate of a j^{th} module in the module chain, and T represents a number of modules in the module chain; and each module chain is processed as a whole in layout processing of automatic optimization.

Further, in the step (b), the module chains obtained in the step (a) are classified into immovable module chains and movable module chains, the immovable module chains refer to the new module chains, and other movable module chains are correspondingly moved around the reference module chain with the immovable module chains as a reference.

Further, the intersection among the module chains is defined as: polygonᵢ∩polygonₖ≠Ø in the step (c), k=1, 2, . . . n, k!=i, and each module chain defines three attributes as location information: (X, Y and SIZE); X and Y respectively represent an X coordinate and a Y coordinate of the module chain in an interface, while SIZE represents a size of the module chain; and after the overlapped status of the module chain is determined according to X, Y and SIZE, the overlapped module chains are marked and moved accordingly.

Further, in the step (d), for all polygonᵢ∈module′, module′ refers to other module sets that exclude the immovable module chains, a minimum distance of polygonᵢ moving towards four directions is obtained, which is to ensure that polygonᵢ∩polygon=Ø, polygon refers to a module chain set that excludes polygonᵢ, and the four moving directions belonging to the polygon and the corresponding moving distance are temporarily recorded; and after all the polygonᵢ are processed, several distances in four directions can be obtained, the maximum one in the four distances is taken, the maximum in each direction is taken, and the maximum distance in the four directions is a distance of the module chain moving towards the direction.

Further, in the step (e), each polygonᵢ∈module′ has a moving direction in the previous step, each of the four directions have several polygonᵢ, among which several polygonᵢ are moved upwardly, which are namely moved towards a direction where a y value is decreased, in all polygonᵢ∈module′, a module chain polygon_{ymax} with the maximum y value is selected, for all polygonᵢ∈module, the y value is determined whether to be less than the y value of polygon_{ymax}′ if the condition is met, the module chain needs to be moved upwardly, and a moving distance is obtained from the previous step; and the same method as the upward moving is used to determine downward, leftward and rightward moving distances.

Compared with the prior art, the present invention has the following advantages and technical effects.

Most current visual programming software can process the interconnection relationship among the programming controls, but the layout among the controls is not well optimized. When the number of the programming controls is increased to a certain scale, the layout can be extremely disordered, and the controls are overlapped with each other, so that it is difficult for the user to use the controls for programming. For the problem above, the present invention is intended to automatically optimize graphical programming control layout to avoid the situations of disordered layout, overlapping of controls with each other and the like. The automatic optimization method for layout can also make the programming interface more friendly and easier to operate, which greatly improves a programming efficiency.

### BRIEF DESCRIPTION OF THE DRAWINGS

FIG. 1 is a flow chart of an automatic optimization method for graphical programming control layout in an embodiment.

### DETAILED DESCRIPTION

The embodiment of the present invention is further described below with reference to the drawing, but the implementation of the present invention is not limited to the embodiment.

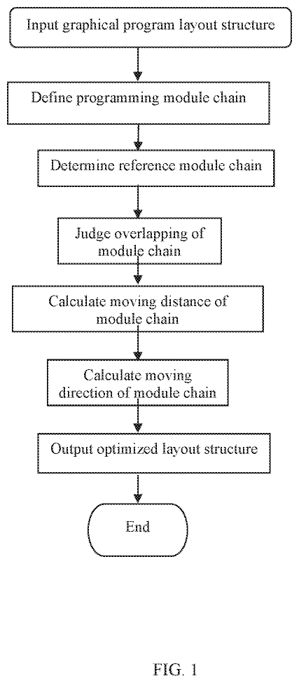

As shown in FIG. 1, an automatic optimization method for graphical programming control layout comprises the following steps of:
(a) defining a module chain;
(b) determining a reference module chain based on the module chain defined in the step (a);
(c) judging an overlapped status of the module chain;
(d) calculating a moving distance of the module chain; and
(e) calculating a moving direction of the module chain and outputting an optimized layout structure.

The method for defining the module chain in the step (a) is to define controls with a parent-child relationship and without a connecting relationship as module chains based on a data structure among controls and a connection status among controls, and after all the programming controls are traversed, n module chains can be obtained:

$$module ( {polygon}_{1} , {polygon}_{2} , … , {polygon}_{n} ) , {polygon}_{i} = \{ ( {x}_{i , j} , {y}_{i , j} ) \vert j = 1 , 2 , … , {m}_{i} \} , ( i = 1 , 2 , … , n ) ,$$

(wherein i represents a module chain number, j represents a module number in a module chain, and x_{i,j}, y_{i,j} represent an abscissa and an ordinate of a j^{th} module in an i^{th} module chain);
a newly added module chain is as follows: Polygon={(xᵢ, yᵢ)|i=1, 2, . . . , T},
(wherein j represents a module number in a module chain, xⱼ, yⱼ represent an abscissa and an ordinate of a j^{th} module in the module chain, and T represents a number of modules in the module chain), and each module chain is processed as a whole in layout processing of automatic optimization.

In the step (b), the module chains are classified into immovable module chains and movable module chains, and other movable module chains are correspondingly moved around the reference module chain with the immovable module chains as a reference.

The intersection among the module chains is defined as: polygonᵢ∩polygonₖ≠Ø (k=1, 2, . . . n, k!=i) in the step (c), and each module chain defines three attributes as location information: (X, Y and SIZE). X and Y respectively represent an X coordinate and a Y coordinate of the module chain in an interface, while SIZE represents a size of the module chain. After the overlapped status of the module chain is determined according to X, Y and SIZE, the overlapped module chains are marked and moved accordingly.

In the step (d), for all polygonᵢ∈module′, a minimum distance of polygonᵢ moving towards four directions is obtained (polygonᵢ∩polygon=Ø is ensured), and the directions and the moving distance are temporarily recorded. After all the polygonᵢ are processed, several distances in four directions can be obtained, the maximum one in the four distances is taken (each one in each direction is taken), and the maximum distance in the four directions is a distance of the module chain moving towards the direction.

In the step (e), each polygonᵢ∈module′ has a moving direction in the previous step, each of the four directions have several polygonᵢ, among which several polygon; are moved upwardly (which are moved towards a direction where a y value is decreased), in all the module chains, a module chain polygon_{ymax} with the maximum y value is selected, for all polygonᵢ∈module, the y value is determined whether to be less than the y value of polygon_{ymax}, if the condition is met, the module chain needs to be moved upwardly, and a moving distance is obtained from the previous step; several polygonᵢ are moved downwardly (which are moved towards a direction where a y value is increased), in all the module chains, a module chain polygon_{ymin} with the minimum y value is selected, for all polygonᵢ∈module, the y value is determined whether to be greater than the y value of polygon_{ymin}, if the condition is met, the module chain needs to be moved downwardly, and a moving distance is obtained from the previous step; several polygon; are moved leftwards (which are moved towards a direction where an x value is decreased), in all the module chains, a module chain polygonₓₘₐₓ with the maximum x value is selected, for all polygonᵢ∈module, the x value is determined whether to be greater than the x value of polygonₓₘₐₓ, if the condition is met, the module chain needs to be moved leftwards, and a moving distance is obtained from the previous step; several polygon; are moved rightwards (which are moved towards a direction where an x value is increased), in all the module chains, a module chain polygonₓₘᵢₙ with the minimum x value is selected, for all polygonᵢ∈module, the x value is determined whether to be less than the x value of polygonₓₘᵢₙ, if the condition is met, the module chain needs to be moved rightwards, and a moving distance is obtained from the previous step. Finally, the optimized layout structure is outputted.

What is claimed is:

1. An automatic optimization method for graphical programming control layout, comprising the following steps of:
(a) defining a programming module chain;
(b) determining a reference module chain based on the module chain defined in the step (a);
(c) judging an overlapped status of the module chain;
(d) calculating a moving distance of the module chain; and
(e) calculating a moving direction of the module chain and outputting an optimized layout structure.

2. The automatic optimization method for graphical programming control layout according to claim 1, wherein the method for defining the module chain in the step (a) is to define controls with a parent-child relationship and without a connecting relationship as module chains based on a data structure among controls and a connection status among controls, and after all the programming controls are traversed, n module chains can be obtained:
$$module ( {polygon}_{1} , {polygon}_{2} , … , {polygon}_{n} ) , {polygon}_{i} = \{ ( {x}_{i , j} , {y}_{i , j} ) \vert j = 1 , 2 , … , {m}_{i} \} ,$$
i=1, 2, . . . , n, wherein i represents a module chain number, j represents a module number in a module chain, and x_{i,j}, y_{i,j} represent an abscissa and an ordinate of a j^{th} module in an i^{th} module chain;
a new module chain formed after a dragging operation of graphical programming is as follows:
Polygon={(xⱼ, yⱼ)|j=1, 2, . . . , T}, wherein j represents a module number in a module chain, xⱼ, yⱼ represent an abscissa and an ordinate of a j^{th} module in the module chain, and T represents a number of modules in the module chain; and
each module chain is processed as a whole in layout processing of automatic optimization.

3. The automatic optimization method for graphical programming control layout according to claim 2, wherein in the step (b), the module chains obtained in the step (a) are classified into immovable module chains and movable module chains, the immovable module chains refer to the new module chains, and other movable module chains are correspondingly moved around the reference module chain with the immovable module chains as a reference.

4. The automatic optimization method for graphical programming control layout according to claim 1, wherein the intersection among the module chains is defined as: polygonᵢ∩polygonₖ≠Ø in the step (c), k=1, 2, . . . n, k!=i, and each module chain defines three attributes as location information: (X, Y and SIZE); X and Y respectively represent an X coordinate and a Y coordinate of the module chain in an interface, while SIZE represents a size of the module chain; and after the overlapped status of the module chain is determined according to X, Y and SIZE, the overlapped module chains are marked and moved accordingly.

5. The automatic optimization method for graphical programming control layout according to claim 1, wherein in the step (d), for all polygonᵢ∈module′, module′ refers to other module sets that exclude the immovable module chains, a minimum distance of polygonᵢ moving towards four directions is obtained, which is to ensure that polygonᵢ∩polygon=Ø, Polygon refers to a module chain set that excludes polygonᵢ, and the four moving directions belonging to the polygon and the corresponding moving distance are temporarily recorded; and after all the polygonᵢ are processed, several distances in four directions can be obtained, the maximum one in the four distances is taken, the maximum in each direction is taken, and the maximum distance in the four directions is a distance of the module chain moving towards the direction.
The automatic optimization method for graphical programming control layout according to claim 1, wherein in the step (e), each polygonᵢ∈module′ has a moving direction in the previous step, each of the four directions have several polygonᵢ, among which several polygonᵢ are moved upwardly, which are namely moved towards a direction where a y value is decreased, in all polygonᵢ∈module′, a module chain polygon_{ymax} with the maximum y value is selected, for all polygonᵢ∈module, the y value is determined whether to be less than the y value of polygon_{ymax}, if the condition is met, the module chain needs to be moved upwardly, and a moving distance is obtained from the previous step; and the same method as the upward moving is used to determine downward, leftward and rightward moving distances.
